(19) United States
(12) Patent Application Publication
(10) Pub. No.: US 2009/0016382 A1
(43) Pub. Date: Jan. 15, 2009

(54) System and Method for High-Speed Applications over a Serial Multi-Drop Communication Network

(75) Inventor: Jean Beaucage, LeGardeur (CA)

Correspondence Address: MERCHANT & GOULD PC, P.O. BOX 2903, MINNEAPOLIS, MN, 55402-0903, US

(73) Assignee: Alstom Canada Inc, Quebec (CA)

(21) Appl. No.: 10/585,492

(22) PCT Filed: Jan. 6, 2005
(86) PCT No.: PCT/CA2005/000006

§ 371 Date: May 27, 2008

(30) Foreign Application Priority Data
Jan. 7, 2004 (CA) 2454983

(51) Int. Cl. H04J 3/06

(52) U.S. Cl. 370/503

(57) ABSTRACT

Broadcasting of high-speed applications over a serial multi-drop communication network is achieved by time-division multiplexing the high-speed applications to produce a data stream, framing the data stream into frames having a header of a size lower than 32 bits and a parity bit, transmitting the frames with pre-emphasis over the serial multi-drop communication network, receiving the frames with de-emphasis from the serial multi-drop communication network, detecting a predetermined bit pattern in the received frames, synchronizing the received frames using an internal clock signal and an external clock signal found within the frames following a phase comparison made after detection of the predetermined bit pattern, and de-framing the synchronized frames into a selected one of the high-speed applications. The system implementing the above process is adapted to broadcast hi-fi audio channels and possibly other types of data to entertainment stations connected to the communication network.

### FIELD OF THE INVENTION

The present invention relates to network communications, and more particularly to a system and a method for high-speed applications over a serial multi-drop communication network. The present invention enables Time Division Multiplexing (TDM) applications, for example the broadcasting of multiple audio stereo channels over, for example an adapted EIA-485 or RS-422 network.

### RELATED ART

EIA-485 (formerly “RS-485”) is a standard serial hardware protocol for multi-drop communication networks that specifies up to 32 drivers and 32 receivers on a single (two-wire) bus. Maximum data rates are 10 Mbps at 1.2 m or 100 Kbps at 1200 m.

Today, some manufacturers are providing EIA-485 transceivers with pre-emphasis and corresponding receiver de-emphasis to double the distance at data rates over 400 kbps. The same devices may be used to increase the data rate for a specific distance (up to 35 Mbps for distances less than 10 m) and to allow up to 128 transceivers on the bus.

EIA-485 is one of the most used multi-drop communication protocols and one of the most economic physical layer protocols. Many electronic devices encompass EIA-485 ports. It is also widely used for electronic systems on-board transit vehicles.

Of interest are the following documents: “Electrical Characteristics of Generators and Receivers for Use in Balanced Digital Multipoint Systems (ANSI/TIA/EIA-485-A-98) (R2003)”; “Comparing Bus Solutions, Application Report SLLA067—March 2000”, Texas Instruments, http://polimage.polito.it/˜lavagno/esd/bus.pdf.

### SUMMARY

An object of the invention is to provide a system and a method which allow sending multiple channels of digital data over a serial multi-drop bus like an EIA-485 bus.

Another object of the invention is to provide a system and a method which reduce an amount of bandwidth required for applications over a serial multi-drop bus.

Another object of the invention is to provide a system and a method which allow a deployment of high-speed applications over longer distances than usual, like across railroad cars.

Another object of the invention is to provide a system and a method which reduce a number of buses required and related equipment.

Another object of the invention is to provide a system and a method which avoid using more expensive multi-drop, multi-point communication protocols.

Another object of the invention is to provide a system and a method embodying a very simple synchronization technique between an encoder, a decoder and a possible repeater.

Another object of the invention is to provide a system which takes very little space from both cabling and equipment perspectives.

According to one aspect of the present invention, there is provided a system for broadcasting multi-channel signals to a receiving station over a two-wire bus, comprising:
an encoder having:
a multiplexer for multiplexing digital data corresponding to the channel signals and producing a data stream; and
a framer connected to the multiplexer, for breaking the data stream up into frames;
a transceiver with pre-emphasis connected to the framer of the encoder and connectable to the two-wire bus;
a receiver with de-emphasis, connectable to the two-wire bus; and
a decoder connected to the receiver and connectable to the receiving station, the decoder having:
   a de-framer for reproducing the digital data corresponding to selected ones of the multi-channel signals from the frames;
   a synchronization circuit for synchronizing the de-framer to the frames; and
   a channel selector circuit connected to the de-framer and controlling which ones of the multi-channel signals are reproduced by the de-framer.

According to another aspect of the invention, there is provided a method of broadcasting high-speed applications over a serial multi-drop communication network, comprising:
time-division multiplexing the high-speed applications to produce a data stream;
framing the data stream into frames having a header and a parity bit, the header having a size lower than 32 bits;
transmitting the frames with pre-emphasis over the serial multi-drop communication network;
receiving the frames with de-emphasis from the serial multi-drop communication network;
detecting a predetermined bit pattern in the received frames;
synchronizing the received frames using an internal clock signal and an external clock signal found within the frames following a phase comparison made after detection of the predetermined bit pattern; and
de-framing the synchronized frames into a selected one of the high-speed applications.

### BRIEF DESCRIPTION OF THE DRAWINGS

A detailed description of preferred embodiments will be given herein below with reference to the following drawings:

FIG. 1 is a schematic diagram of an end-to-end network architecture for an in-seat audio entertainment system according to the invention.

FIG. 2 is a schematic diagram of an audio encoder according to the invention.

FIG. 3 is a schematic diagram of an audio decoder according to the invention.

FIG. 4 is a schematic diagram of a data repeater according to the invention.

FIG. 5 is a schematic diagram of a data frame format according to the invention.

### DETAILED DESCRIPTION OF THE PREFERRED EMBODIMENTS

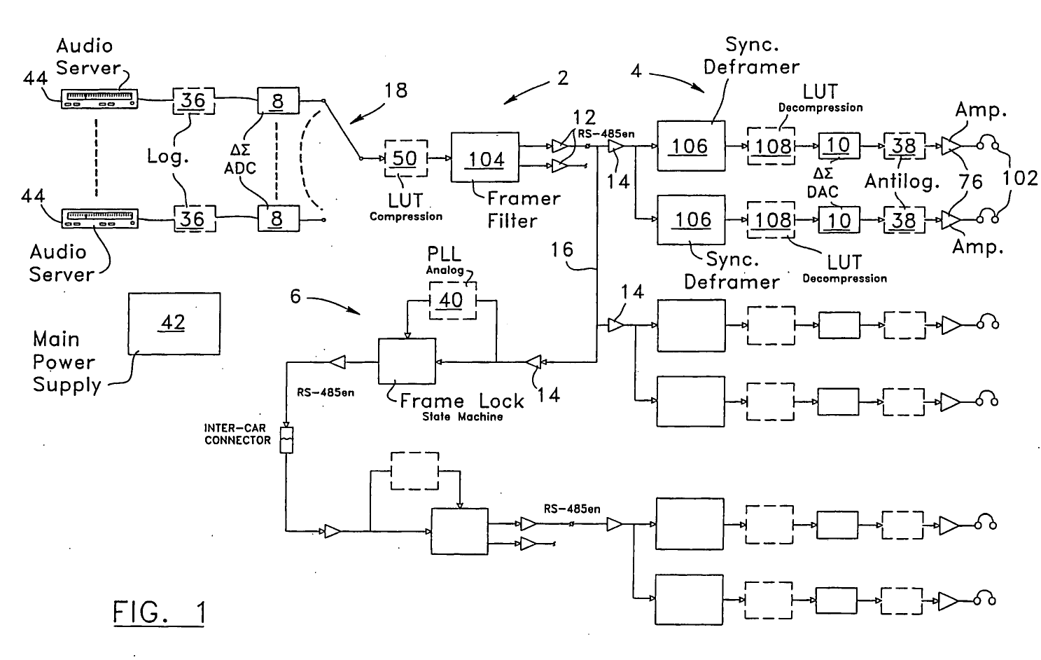

Referring to FIG. 1, there is shown an end-to-end system for broadcasting audio stereo multi-channel signals with hi-fi quality to individual passenger seats on-board a public transit vehicle via a multi-drop communication network 16 also referred to hereinafter as a two-wire bus. The system comprises an audio encoder 2, an audio decoder 4 and a data repeater 6. The encoder 2 performs the data ADC conversion (if necessary) and framing. Up to five uncompressed or ten compressed stereo channels can be sent on one single RS-485 channel. The audio decoder 4 can be in the armrest of a user seat (not shown). Additional decoders 4 may be connected to the network 16 for servicing more passengers so that each passenger may choose the audio channel that he/she wants to hear for his/her entertainment. The data repeater 6 is used to rebuild, clean up and repeat the RS-485 signal to another segment of the serial multi-drop communication network, for example, in a next car (not shown) if desired.

The same system can be used to provide other applications, for example internet servicing, passenger appliance control, etc. in other contexts, for example in an airplane, a cruise ship, a CD/DVD store, etc. The repeater 6 may be provided only when necessary.

The illustrated system combines a number of devices in a new and original way. In this respect, Delta-Sigma analog-to-digital converters (ADC) 8 and digital-to-analog converters (DAC) 10 are used for the analog-to-digital conversion and vice-versa. These types of converters provide oversampling and closed-loop modulation, the combination of which results in a higher quality digital signal.

Delta-Sigma ADC converter type differs from other ADC approaches by sampling the input signals at a much higher rate than the maximum input frequency. Traditional, non-oversampling converters such as successive approximation ADCs perform a complete conversion with only one sample of the input signal. Another unique characteristic of the Delta-Sigma converter type is that a closed-loop modulator (not shown) is used. The modulator not only continuously integrates the error between a crude ADC and the input signal, but also attenuates noise. This combination of oversampling and closed-loop modulation creates a very powerful technique.

Delta-Sigma concept can also be applied on DAC converter type. The main difference between Delta-Sigma ADC and DAC types lies in the rate of the output signal. In the ADC section, decimation is used to reduce the high frequency low-resolution pulses to lower frequency, higher resolution words. Delta-Sigma DAC type, on the other hand, do the reverse. Here, interpolation that samples the digital outputs at a higher rate is performed. This produces a high-resolution/frequency output that is easily low pass filtered for an analog output.

Another technology that is used is EIA-485 transceivers with pre-emphasis 12 and corresponding receivers with de-emphasis 14, which extends the distance and increases the data rate of reliable communication on the bus 16 by reducing intersymbol interference (ISI) caused by long cables. The transceivers 12 are preferably programmable for data rates up to 10 Mbps and they allow up to 128 transceivers on the bus 16. The pre-emphasis drivers may incorporate four voltage levels (strong high, strong low, normal high, normal low). Pre-emphasis is necessary only when the data pattern changes and not during the intervals when the voltage remains at the same logic level.

In order to reduce the overall cost of an in-seat audio entertainment system, a modified, enhanced EIA-485 bus can be selected as the digital data link between the encoder 2 and the decoder 4. EIA-485 has three major advantages: it is a bus, it is multi-drop and it is an economic technology for the application. A challenge resides in sending five (5) uncompressed digital stereo hi-fi channels on a 10 Mbps limited channel. The audio by itself requires 7.056 Mbps. The more the data rate is increased, the more potential error may occur.

The digital audio network 16 can transport up to 5 stereo audio streams (10 in phase 2), involving streaming. Pre-emphasis allows achieving higher data rates with more loads.

EIA-485 is a physical layer protocol. Different packet formats may be implemented for the data layer over an EIA-485 bus. Simple ASCII commands are often provided. Typically, the minimum overhead is 32 bits (4 bytes), which is not optimal for some applications. In the present invention, a 16 bits overhead is proposed.

E1/T1 multi-channel broadcasting devices are available. E1 supports a 2 Mbps rate and T1 supports 1.5 Mbps, whereas improved EIA-485 devices support up to 35 Mbps. Therefore, for the same sampling frequency and quality (44.1 kHz for hi-fi stereo quality), less channels would be supported by an E1/T1 solution.

Furthermore, E1/T1 is a point-to-point solution. To adapt it to a multi-drop network, additional devices would be required, increasing complexity and costs.

A multiplexer 18 is used to perform time-division multiplexing (TDM) of the channels over the EIA-485 bus 16. The same multiplexing principle may be applied to other communication protocols, for example RS-422 to enable other applications.

In a possible embodiment, the uncompressed audio data produced by the analog-to-digital converters 8 is 16 bits per channel and each channel is sampled at 43.17 kHz.

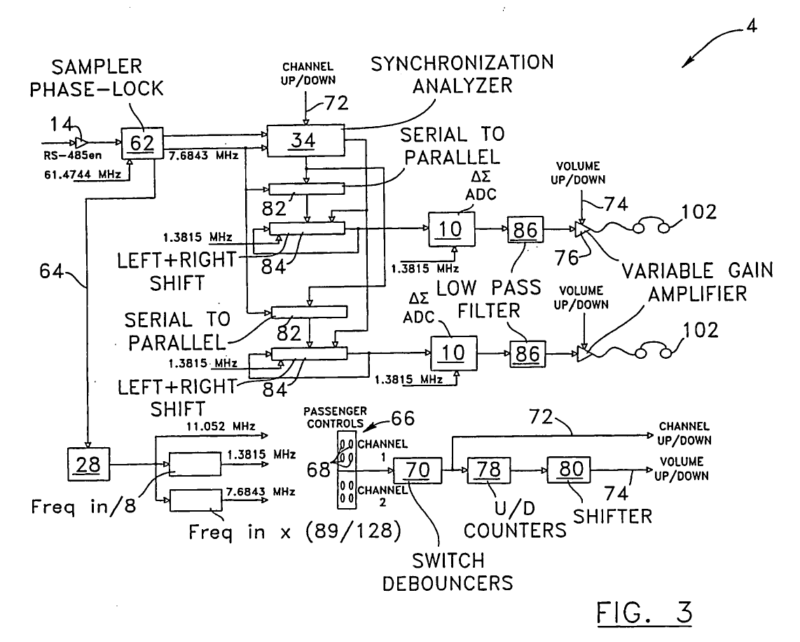

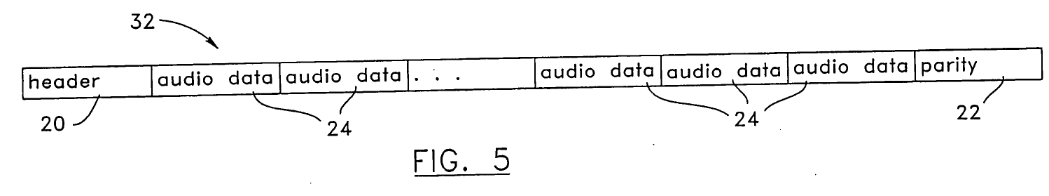

The invention thus implements several data channels multiplexed in TDM format and sent over a single EIA-485 bus. In this respect, the system can be used to broadcast multi-channel signals (e.g. produced by a number of audio servers 44) to one or more receiving stations 102 (e.g. audio listening stations) over a two-wire bus 16 (a.g. a EIA-485 bus). The encoder 2 of the system has a multiplexer 18 for multiplexing digital data corresponding to the channel signals (e.g. generated by the audio servers 44) and producing a data stream. A framer 104 is connected to the multiplexer 18, for breaking the data stream up into frames 32 (see FIG. 5). A transceiver with pre-emphasis 12 is connected to the framer 104 of the encoder 2 and is connectable to the two-wire bus 16. A receiver with de-emphasis 14, connectable to the two-wire bus 16, is provided. The decoder 4 of the system is connected to the receiver 14 and is connectable to the receiving station 102. The decoder 4 has a de-framer/synchronization circuit 106 for reproducing the digital data corresponding to selected ones of the multi-channel signals from the frames 32 and for synchronizing the de-framer to the frames 32, and a channel selector circuit 66 (as shown in FIG. 3) connected to the de-framer 106 and controlling which ones of the multi-channel signals are reproduced by the de-framer 106.

The encoder 2 may have delta-sigma analog-to-digital converters 8 for converting the multi-channel signals into digital form for the multiplexer 18. Likewise, the decoder 4 may have a delta-sigma digital-to-analog converter 10 connected to the de-framer 106 for converting the digital data corresponding to the selected ones of the multi-channel signals into analog form for the receiving station 102. In the case where the multi-channel signals are already in digital form, then the encoder 2 may be deprived of the converters 8. Also, in the case where the receiving station 102 has a digital input, then the decoder 4 may be deprived of the converters 10.

Broadcasting of high-speed applications over a serial multi-drop communication network can be done with the system by time-division multiplexing the high-speed applications to produce a data stream, framing the data stream into frames 32 having a header 20 of a size lower than 32 bits and a parity bit 22, transmitting the frames 32 with pre-emphasis over the serial multi-drop communication network 16, receiving the frames 32 with de-emphasis from the serial multi-drop communication network 16, detecting a predetermined bit pattern in the received frames 32, synchronizing the received frames 32 using an internal clock signal and an external clock signal found within the frames 32 following a phase comparison made after detection of the predetermined bit pattern, and de-framing the synchronized frames 32 into a selected one of the high-speed applications.

Referring to FIG. 5, a data frame format and protocol are provided to multiplex the TDM signals 24 over the EIA-485 bus with a header 20 of minimal size and inclusion of error correction 22. According to the invention, the EIA-485 overhead can be, for example, reduced to 18 bits in uncompressed format, which is lower than any commercially available implementation. Each uncompressed stereo channel contains 32 bits. Five separate channels sampled at 43.17 kHz may be multiplexed in TDM format and sent over a single EIA-485 bus. The necessary bandwidth for a 5 uncompressed stereo channel is:

((5 channels×3 (stereo)×16 bits)+17 bits (header)+1 bit (parity))×43.17 kHz=7.6843 Mbps

The necessary bandwidth for a 10 compressed (16 to 10) stereo channels is:

((10 channels×2 (stereo)×10 bits)+11 bits (header)+1 bit (parity))×43.17 kHz=9.152 Mpbs

In fact, up to 6 simultaneous uncompressed channels (up to 10 compressed channels) could be supported by a single EIA-485 bus because the total bandwidth is less than 10 Mbps. However, it is always an advantage to consume the least amount of bandwidth possible, because the more the 10 Mbps limit is approached, the higher the probability of potential errors.

For a synchronization purpose, a header size of 17 bits (11 in the case where compression is used) is preferably used, and a parity bit 22 is preferably included. Thus, the overhead is reduced to optimize bandwidth usage, compared to conventional systems having a minimum overhead of 32 bits.

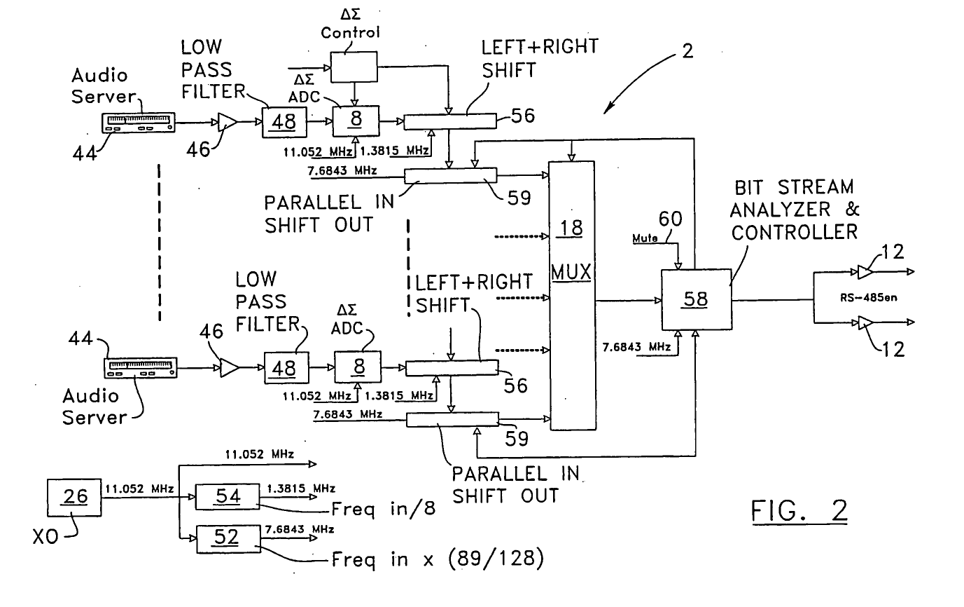

Referring also to FIG. 1, synchronization between the encoder 2, the decoder 4 and the repeater 6 may be achieved using a crystal oscillator 26, 28, 30 (as shown in FIGS. 2, 3 and 4) provided in each device, so that the synchronization does not require any adjustments. Synchronization may be performed by locking the phase between a local clock signal and an external clock signal found within an incoming data stream. A phase comparison may be set to always occur after, for example, at least four consecutive high bits are detected in the header 20 of a frame 32, to give always the same threshold for the phase comparison. The phase is then locked for the next four-bit pattern. The header 20 has at least four consecutive high bits to guarantee that the phase comparison and the phase lock are performed at least once for every message or frame 32.

Error management that in the audio application would allow a end-user to hear no audible difference in case of errors may be also provided. For any communication network, there is some data corruption probability. In order to manage such potential problem, a parity bit 22 is provided to check the data integrity. The parity is part of each frame 32 of, for example, 178 bits. It should be enough to keep a good and reliable audio quality. If an error occurs, the analyzer 34 (as shown in FIG. 3) will not be able to select the wrong data position, so the error handling strategy is to send the previous audio data again. The same strategy is valid if the frame detection is lost or the phase locked is missing. The last two events should be exceptional.

Logarithmic compression can be used to increase the number of data channels that can be transmitted over a single EIA-485 data link. A logarithmic encoder/decoder 36, 38 can be employed in order to use a greater portion of the available levels for weak signals. This process can be thought of as compressing the signal in amplitude. Using this technique, it is possible to achieve up to 10 audio stereo channels on a single EIA-485 data link.

Even if the functionality of the network repeater 6 may seem to be very simple, this module is complex. It uses the same kind of technology developed for the audio decoder 4 for data tracking but emphasis is focused on high tracking precision instead of highly reactive tracking. The repeater task is to reduce jittering, wandering and keep data integrity.

Jitter attenuation through the network 16 may be achieved based on analog and/or digital phase locked loop 40. Signal jitter is primarily due to intersymbol interference (ISI). ISI is the net effect of several causes of signal degradation. One cause is the attenuation and the dispersal of frequency components that result from signal propagation down a transmission line. Another cause is the variation of rise and fall times that follows the varying sequences of one and zero known as “pattern-dependent skew”. A data pulse responds to these effects with a loss of amplitude, displacement in time, rounded edges, and a “smearing” of the pulse into adjacent time slots, or unit intervals. By locking the phase of the repeater 6 on one particular, intentionally generated, clean pulse, the rest of the audio data stream can be sampled based on this phase and therefore most of the jitter can be removed.

To reduce the cost of the overall system, it may be decided to blind broadcast the signals through the cars. A simple but powerful error remodeling may be implemented at the decoder level. The repeater task will be to provide a clean error free, jitter attenuated signal for the next car.

A common power source 42 for all the system components is provided. The selected secondary isolated voltage may be 12 V. Each equipment should preferably provide its own isolated power supply. The primary voltage can be the usual ones. Each system component has an RS-485 enhanced serial port (not shown). In order to reduce any ground looping and to stay within the standard limits, all communication interfaces are preferably isolated.

The encoder 2 digitizes five analog stereo channels generated by audio servers 44. In order to be able to reach hi-fi levels, Delta-Sigma converters 8 are used. The analog interface between the audio servers 44 and the Delta-Sigma converters 8 may be formed of amplifiers 46 and low pass filter 48. The amplifiers 46 are provided to match the conversion level and the low pass filters 48 are provided to reduce possible aliasing distortion. LUT (Look-Up Table) compression 50 and decompression 108 (as shown in FIG. 1) can be included if desired.

One challenge is to send 5 uncompressed digital stereo hi-fi channels on a 10 Mbps limited channel. The audio by itself requires 6.907 Mbps. More the data rate increases, more jitter and potential error occur. The overhead is reduced by just adding a 17-bit header 20 and one parity bit 22 (as shown in FIG. 5). If, somewhere in the data stream, the same pattern as the header 20 occurs, then the actual audio channel may just be replaced by 0 provided that the decoder 4 is designed to manage this information.

The design of the header 20 provides immunity against any problems. The header 20 has less transitions then the audio data in order to give a very good eye pattern at the line level. By using one parity bit 22 for a complete audio frame 32, a very effective way to detect error in each frame 32 may be achieved.

Different frequencies are necessary to produce an audio data stream at the right bit rate. Actually, the frequency relation between the output bit rate and the reference frequency is 0.6953125 (89/128). This relation comes from the amount of channels sent and the overhead added to the data versus the sampling rate of the oversampling converters 8. To generate such a frequency, a phase-locked loop with one programmable divider 52 in the feedback loop (N) and one at the output (M) can be used. The frequency generated will then be Fout=Fref*N/M. Another programmable divider 54 dividing the frequency 11.052 MHz of the crystal oscillator 26 by 8 produces a 1.3815 MHz signal for use by the shift registers 56 while parallel-to-serial converters 59 and bit stream analyzer and controller 58 breaking the data stream up into frames are clocked by the divider 52.

A way to mute all the digital audio channels may be provided. A mute command 60 may come from an external device (not shown). A way this feature may be implemented is to continue sending the previous data as long as the mute command 60 is active.

It is very hard to test an audio system with real data. Audio data is complex and following its path through a system would be a complex task. In order to ease the testing of the complete system, a pattern generator (not shown) may be implemented in one of the audio servers 44. Instead of getting samples from the ADC converters 8, some predefined patterns from the pattern generator are obtained.

Referring to FIG. 3, the audio decoder 4 is the most challenging part of the system. Even if it is complex, it remains inexpensive. The decoder 4 has the capability to give hi-fi sound quality even in harsh environment. The complete system is designed to provide good quality sound without any feedback to the encoder 2. The decoder 4 synchronizes to incoming data stream, extracts the stereo channels, checks if there is a possible data corruption and takes action. Even if corruption happens, the listener does not hear any glitch.

The basic frequency is the same between the encoder 2 and the decoder 4. Even if they are both crystal based, oscillators have some part per million of frequency variations. The strategy here is to sample the data in at 8 times the incoming data rate and test the phase relation with the internal reference. The algorithm enables the reference to have some phase variations. With time, this variation will become unacceptable and the phase correction will then occur. A feedback 64 from the sampler stage 62 to the voltage-controlled crystal oscillator (VCXO) 28 can be seen. Even if the oscillator 28 is crystal based, its frequency can be varied up to ±100 ppm. Using this feature, it is possible to avoid any slip buffer to happen because the frequency reference will always be locked on the incoming data stream. The phase comparison may be set to always occur after at least four consecutive high bits in the header 20, so that this will always give the same threshold for the phase comparator (in the sampler stage 62). The phase is then locked for the next four-bit pattern (the header has such pattern).

The architecture illustrated in FIG. 3 does not reflect the possible decompression function. This optional feature can be based on the following simple principle: an antilogarithm function is encoded into a dedicated memory 38 (as shown in FIG. 1). This function is the reversal of the logarithmic function in the memory 36 of the encoder 2. With such functions, a good signal dynamic with a minimum distortion can be obtained.

The user interface 66 may be limited to four push buttons 68 for selection of the channels and for adjustment of the volume. Each switch of the buttons 68 is de-bounced by debouncers 70 and the corresponding command, e.g. channel up/down 72 and volume up/down 74 is sent to the right stage, i.e. the analyzer 34 and variable gain amplifiers 76. The volume control can be made using logarithmic digital potentiometers having their own counter 78 and shift register 80 receiving their value through a serial port. For the channel selection, all the design process is controlled and a simple counter for each channel is implemented in the analyzer 34.

For any communication network, there is some data corruption probability. In order to manage such potential problem, a parity bit 22 (see FIG. 5) is provided to check the data integrity. The parity is part of each frame 32 of 178 bits, which should be enough to keep a good and reliable audio quality. If an error occurs, the analyzer 34 will not be able to select the wrong data position. The error handling strategy is to use the previous audio data again. The de-framer 106 is thus adapted to use the previous frame 32 when an error condition is detected in a current frame. The same strategy is valid if the frame detection is lost or the phase locked is missing. The last two events should be exceptional.

The configuration of a regular digital audio network is to have one audio encoder 2 for up to hundreds of audio decoders 4. This high volume production requires the design to be quick to check by manufacturing staff. The decoder design surrenders the user's control to an external intelligent device (not shown). This device should be adapted to send volume and channel up/down commands and to check for audio harmonic distortion and communication reliability. This device may also have the task to check if the push button interface 66 is correct. All the production tests may use a 3 wire interface: data; clock; load.

The audio decoder 4 requires no adjustments. The only thing to set in the field is putting the strap for the RS-485 terminals if necessary.

The decoder 4 decodes the incoming frames using serial-to-parallel decoders 82 and shift registers 84 under control of the analyzer 34. Low-pass filters 86 may be provided to filter the selected audio channel before amplification.

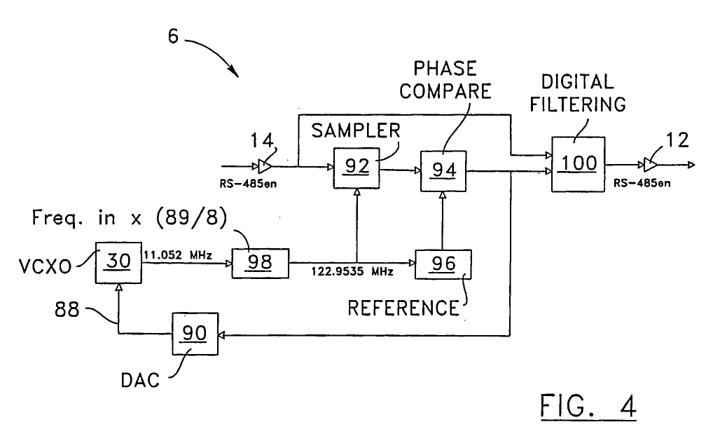

Referring to FIG. 4, the data repeater 6 uses the same kind of technology developed for the audio decoder 4 for the data tracking but the emphasis is focused on the high tracking precision instead of highly reactive tracking. The repeater task is to reduce jittering, wandering and keep data integrity.

As just mentioned, the strategy for phase tracking is similar as for the audio decoder 4: a sampler circuit 92 is locked on the incoming data through a feedback circuit comprising a phase comparison circuit 94, a digital-to-analog converter (DAC) 90, the voltage-controlled crystal oscillator 30, a programmable divider 98 and a reference circuit 96. The big difference between the decoder 4 and the repeater 6 is in its great accuracy. Instead of sampling the incoming data at 8 times its frequency, it is sampled at 16 times. More, instead of having a feedback with three different conditions (+100 ppm, 0 ppm, −100 ppm), a 16 levels feedback 88 to the voltage-controlled crystal oscillator (VCXO) 30 is added. The comparison 10 could happen once per frame only and the phase would be locked for the rest of the data stream. The event that triggers the phase locking may be a particular pattern found in the header 20. This header 20 reduces the electrical effects relative to the communication cable.

Transmission lines are not immune against electrical spikes or high-energy radiation burst. In order to reduce data corruption at the repeater level, some digital filtering on the incoming data may be provided by a digital filter 100. The filtering may be achieved by sampling the incoming data many times in its valid period of time and making a correlation between the samples.

The present invention solves several problems of the art. It provides an end-to-end system that allows the sending of multiple channels of digital data over a single EIA-485 bus. It reduces the amount of bandwidth required for applications over EIA-485. It allows the deployment of high-speed applications over longer distances. It reduces the number of buses required, and related equipment. It avoids the usage of more expensive multi-drop, multi-point communication protocols. A very simple synchronization technique between the encoder, the decoder and the repeater is developed. A method to correct corrupted data is also provided. Logarithmic compression is proposed to further increase the number of channels supported on a single EIA-485 bus. The invention takes very little space from both cabling and equipment perspectives. Space economy is a big advantage for deployment in transit vehicles.

The present invention defines the protocols in the physical layer and the protocols above the physical layer to allow the sending of Time Division Multiplexing (TDM) based digital data signals over an EIA-485 bus at a rate up to 10 Mbps at a distance exceeding 150 m.

It should be understood that changes and modifications may be made in the above embodiments without departing from the essence of the invention. For example, the decoder 4 may have two delta-sigma digital-to-analog converter 10 connected to the de-framer (made of circuits 34, 82, 84), for converting the digital data corresponding to two independently selected multi-channel signals intended to two stations 102. A same receiver 14 may be connected to multiple decoders 4.

1. A system for broadcasting multi-channel signals to a receiving station over a two-wire bus, comprising:
an encoder having:
a multiplexer for multiplexing digital data corresponding to the channel signals and producing a data stream;
a framer connected to the multiplexer, for breaking the data stream up into frames, and for inserting into said frame a header containing at least a predetermined pattern;
a transceiver with pre-emphasis connected to the framer of the encoder and connectable to the two-wire bus;
a receiver with de-emphasis, connectable to the two-wire bus, said receiver including:
a decoder connectable to the receiving station, the decoder having a de-framer for reproducing the digital data corresponding to selected ones of the multi-channel signals from the frames, said de-framer being adapted to use a previous frame when an error condition is detected in a current frame;
a synchronization circuit using a pattern-oriented phase-locked loop for sampling the incoming data stream using said predetermined pattern, and for regenerating a system clock; and
a channel selector circuit connected to the de-framer and controlling which ones of the multi-channel signals are reproduced by the de-framer.

2. The system according to claim 1, wherein:
the encoder has delta-sigma analog-to-digital converters for converting the multi-channel signals into digital form for the multiplexer; and
the decoder has a delta-sigma digital-to-analog converter connected to the de-framer for converting the digital data corresponding to the selected ones of the multi-channel signals into analog form for the receiving station.

3. The system according to claim 2, wherein the encoder comprises analog interfaces respectively having amplifiers in series with low pass filters for amplifying and filtering the multi-channel signals transmitted to the delta-sigma analog-to-digital converters.

4. The system according to claim 1, wherein:
the encoder comprises a compression circuit for compressing the digital data input into the framer; and
the decoder comprises a decompression circuit for decompressing the digital data output by the de-framer.

5. The system according to claim 4, wherein the compression circuit and the decompression circuit have look-up tables defining compression and decompression functions respectively.

6. The system according to claim 4, wherein the compression circuit and the decompression circuit respectively have logarithmic and antilogarithmic functions.

7. The system according to claim 1, wherein the multiplexer has a time division multiplexing function.

8. The system according to claim 1, wherein said header has less transitions than transitions in the digital data.

9. The system according to claim 8, wherein the header has a size of 17 bits.

10. The system according to claim 1, wherein the frames comprise a parity bit for data integrity check by the decoder.

11. The system according to claim 1, wherein the synchronization circuit comprises a sampling circuit for sampling the frames in at a number of times an incoming data rate, a test circuit for testing a phase relation of the frames with an internal reference, and a phase lock loop circuit responsive to the test circuit for phase correction of the synchronization circuit.

12. The system according to claim 12, wherein the test circuit is adapted to perform a phase comparison after finding a predetermined bit pattern in the data stream.

13. The system according to claim 1, wherein the channel selector circuit comprises a user interface for selection of said ones of the multi-channel signals.

14. The system according to claim 1, wherein the decoder has a variable gain amplifier for amplifying the selected ones of the multi-channel signals, and a user interface for adjusting a gain of the variable gain amplifier.

15. The system according to claim 1, wherein the de-framer comprises a synchronization analyzer receiving a signal indicative of the selected ones of the multi-channel signals, and serial to parallel converting circuitry controlled by the analyzer for providing the digital data into parallel form.

16. The system according to claim 1, further comprising a data repeater connectable between the two-wire bus and an additional two-wire bus, for rebuilding, cleaning up and repeating the frames for transmission on the additional two-wire bus.

17. The system according to claim 16, wherein:
the data repeater comprises a sampler for sampling the frames in at a number of times an incoming data rate, a test circuit for testing a phase relation with an internal reference, a feedback circuit responsive to the test circuit for correction of the internal reference used by the sampler and the test circuit, and a correction circuit for phase correction of the frames going out from the repeater; and
the system further comprising a transceiver with pre-emphasis connected to the data repeater and connectable to the additional two-wire bus.

18. The system according to claim 17, wherein the data repeater has a phase locked on one clean pulse intentionally generated by the encoder, the frames being sampled by the sampler based on the phase.

19. The system according to claim 17, wherein the correction circuit comprises a digital filter.

20. The system according to claim 17, wherein the number of times is higher than a number of times the frames are sampled by the decoder.

21. The system according to claim 1, wherein the multi-channel signals comprise multiple channels of audio stereo signals, and the receiving station comprises an audio listening station.

22. The system according to claim 1, wherein the multi-channel signals comprise high speed applications.

23. The system according to claim 2, wherein the decoder has at least one additional delta-sigma digital-to-analog converter connected to the de-framer, for converting the digital data corresponding to additional selected ones of the multi-channel signals.

24. The system according to claim 1, wherein the receiver has outputs for connection to the decoder and to additional like decoders.

25. The system according to claim 1, wherein the two-wire bus forms a serial multi-drop communication network.

26. A method of broadcasting high-speed applications over a serial multi-drop communication network, comprising:
time-division multiplexing the high-speed applications to produce a data stream;
framing the data stream into frames having a header and a parity bit, the header having a size lower than 32 bits;
transmitting the frames with pre-emphasis over the serial multi-drop communication network;
receiving the frames with de-emphasis from the serial multi-drop communication network;
detecting a predetermined bit pattern in the received frames;
synchronizing the received frames using an internal clock signal and an external clock signal found within the frames following a phase comparison made after detection of the predetermined bit pattern; and
de-framing the synchronized frames into a selected one of the high-speed applications.

27. The method according to claim 26, further comprising analog-to-digital converting the high-speed applications prior to the multiplexing, and digital-to-analog converting the selected one of the high-speed applications after the de-framing.

28. The method according to claim 27, wherein the analog-to-digital converting and the digital-to-analog converting comprise over sampling and closed-loop modulating the high-speed applications.

29. The method according to claim 26, wherein the high-speed applications comprise a multi-channel signal broadcast.

30. The method according to claim 26, further comprising parallel to series converting the high-speed applications prior to the multiplexing, and series to parallel converting the selected one of the high-speed applications.

31. The method according to claim 26, further comprising checking data integrity of the synchronized frames using the parity bit.

32. The method according to claim 31, wherein a previously received frame is used when an error condition is detected in a currently received frame.

33. The method according to claim 26, wherein the high-speed applications comprise a multi-channel audio signal broadcast to audio listening stations connected to the serial multi-drop communication network.

34. The method according to claim 26, wherein the predetermined bit pattern is located in the header of the frames.

35. The method according to claim 26, further comprising compressing the high-speed applications prior to the framing, and decompressing the selected one of the high-speed applications after the de-framing.

36. The method according to claim 26, further comprising repeating the frames for transmission over another segment of the serial multi-drop communication network.

37. The method according to claim 26, wherein the repeating comprises sampling the frames in at a number of times an incoming data rate, testing a phase relation with an internal reference, phase correcting the frames going out to the other segment, and transmitting the frames with pre-emphasis to the other segment.

38. The method according to claim 37, further comprising inserting a clean pulse in the frames, and locking a phase on the clean pulse for sampling the frames.

39. The method according to claim 37, wherein the number of times is higher than a number of times the frames are sampled in the synchronizing.
